(19) United States
(12) Patent Application Publication
(10) Pub. No.: US 2022/0121778 A1
(43) Pub. Date: Apr. 21, 2022

(54) SYSTEMS AND METHODS FOR MODIFYING COMPUTER-EXECUTABLE INSTRUCTIONS TO REMOVE PERSONAL INFORMATION

(71) Applicant: SHOPIFY INC., Ottawa (CA)

(72) Inventors: NEIL LEONARD PADGETT, Toronto (CA); JOHN JONG-SUK LEE, Waterloo (CA)

(21) Appl. No.: 17/072,228

(22) Filed: Oct. 16, 2020

(51) Int. Cl. G06F 21/62; G06F 16/958; G06Q 30/06

(52) U.S. Cl. CPC G06F 21/6254; G06Q 30/0641; G06F 16/958

(57) ABSTRACT

The present disclosure provides systems and methods to locate, remove and optionally replace personal information in screen pages generated by computer-executable instructions. According to an embodiment, a method includes obtaining computer-executable instructions for generating multiple screen pages. At least one of the screen pages includes personal information that a user might not have permission to view. The computer-executable instructions can then be modified to produce modified computer-executable instructions, which generate at least one modified screen page that corresponds to the at least one screen page having the personal information removed. The modified computer-executable instructions are transmitted to a device associated with the user, allowing the user to interact with the at least one modified screen page without risking disclosure of the personal information.

### FIELD

The present application relates to computer-executable instructions, and in particular embodiments, to modifying computer-executable instructions to preserve/protect privacy.

### BACKGROUND

Many software instances are restricted to certain individuals. A user account page provided by a computing platform is an example of a software instance that is typically restricted to a single user. For example, the user account page may enable access to personal information that should not be shared with other individuals. The user may have to enter a username and password to gain access to their account page. However, restricting all other individuals from the user account page can hinder the development of the computing platform.

### SUMMARY

In some embodiments, a computer-implemented method is used to locate, remove and optionally replace personal information that is provided by a software instance. The software instance can generate multiple screen pages, where one or more of these screen pages display the personal information. While there might be no issue with displaying the personal information to some users of the software instance, such as the user that the personal information relates to, for example, other individuals might not be permitted to view the personal information. In some cases, this could hinder software development. By way of example, translators, software developers and software support personnel might need to access at least a portion of the software instance to effectively perform their functions. Accordingly, the computer-implemented method can be used to provide a modified version of the software instance. The modified version of the software instance generates one or more modified screen pages where the personal information has been located, removed and optionally replaced. The modified version of the software instance could then be provided to, and utilized by, a wide variety of users without risking disclosure of the personal information.

According to an aspect of the present disclosure, there is provided a computer-implemented method that includes obtaining computer-executable instructions for generating a plurality of screen pages. The method also includes determining that particular elements of at least one screen page of the plurality of screen pages include personal information. This determination may be based on metadata associated with elements of screen pages of the plurality of screen pages. The personal information can include at least one of a name, a location, a date, an identification number, financial information, medical information and biometric information. The method further includes modifying the computer-executable instructions to produce modified computer-executable instructions. The modified computer-executable instructions are to generate at least one modified screen page that corresponds to the at least one screen page having the particular elements of the at least one screen page removed and optionally replaced with corresponding elements including non-personal information corresponding to the personal information. The modified computer-executable instructions can be transmitted to a device.

In some embodiments, modifying the computer-executable instructions includes obtaining non-personal content that corresponds to the personal information. The at least one modified screen page includes the non-personal content in place of the personal information. The non-personal content can be retrieved from memory and/or generated based on the plurality of screen pages.

In some embodiments, when executed by the device, the modified computer-executable instructions are to display the at least one modified screen page and to display the screen pages of the plurality of screen pages other than the at least one screen page.

In some embodiments, the computer-executable instructions generate action elements to navigate between the plurality of screen pages. The modified computer-executable instructions also generate the same or similar action elements to navigate between the at least one modified screen page and the screen pages of the plurality of screen pages other than the at least one screen page.

In some embodiments, the determination that particular elements of the at least one screen page include personal information is further based on a comparison between a content field in the at least one screen page and a list of predefined content fields stored in memory.

In some embodiments, determining that particular elements of the at least one screen page comprise personal information includes identifying, based on the metadata associated with the elements of the plurality of screen pages, a first subset of elements of the at least one screen page comprising personal information; and identifying, using at least one probabilistic technique, at least one further element of the at least one screen page not in the first subset of elements and considered likely to also comprise personal information. In these embodiments, the particular elements determined to comprise personal information may be the elements of the first subset of elements and the at least one further element.

In some embodiments, the method further includes obtaining a record of the computer-executable instructions being executed on another device.

In some embodiments, prior to transmitting the modified computer-executable instructions to the device, the method includes determining that the device is associated with a user account not having permission to access the personal information.

In some embodiments, transmitting the modified computer-executable instructions to the device includes transmitting the modified computer-executable instructions to a translator to translate text in the plurality of screen pages.

According to another aspect of the present disclosure, there is provided a system including a memory to store computer-executable instructions, and one or more processors to perform any method as disclosed herein.

According to a further aspect of the present disclosure, there is provided a non-transitory computer readable medium storing computer executable instructions which, when executed by a computer, cause the computer to perform any method disclosed herein.

### BRIEF DESCRIPTION OF THE DRAWINGS

Embodiments will be described, by way of example only, with reference to the accompanying figures wherein:

FIG. 1 is a block diagram of an e-commerce platform, according to one embodiment;

FIG. 2 is an example of a home page of an administrator, according to one embodiment;

FIG. 3 illustrates the e-commerce platform of FIG. 1, but including a software instance modification engine;

FIG. 4 is a block diagram illustrating a system for modifying software instances, according to an embodiment;

FIG. 5 is a flow diagram illustrating a method for modifying software instances, according to an embodiment;

FIGS. 6 to 9 illustrate multiple screen pages that are generated by a software instance, according to an embodiment; and

FIGS. 10 to 12 illustrate multiple screen pages that are generated by a modified version of the software instance that generated the multiple screen pages of FIGS. 6 to 9.

### DETAILED DESCRIPTION

For illustrative purposes, specific example embodiments will now be explained in greater detail below in conjunction with the figures.

### Example e-Commerce Platform

In some embodiments, the methods disclosed herein may be performed on or in association with a commerce platform, which will be referred to herein as an e-commerce platform. Therefore, an example of an e-commerce platform will be described.

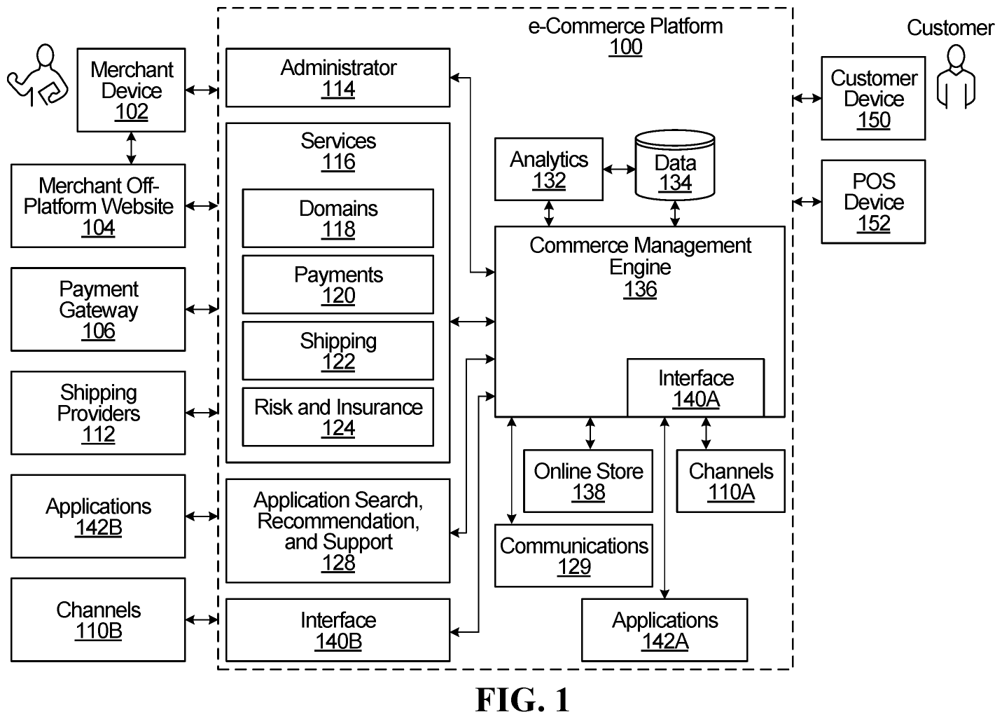

FIG. 1 illustrates an e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

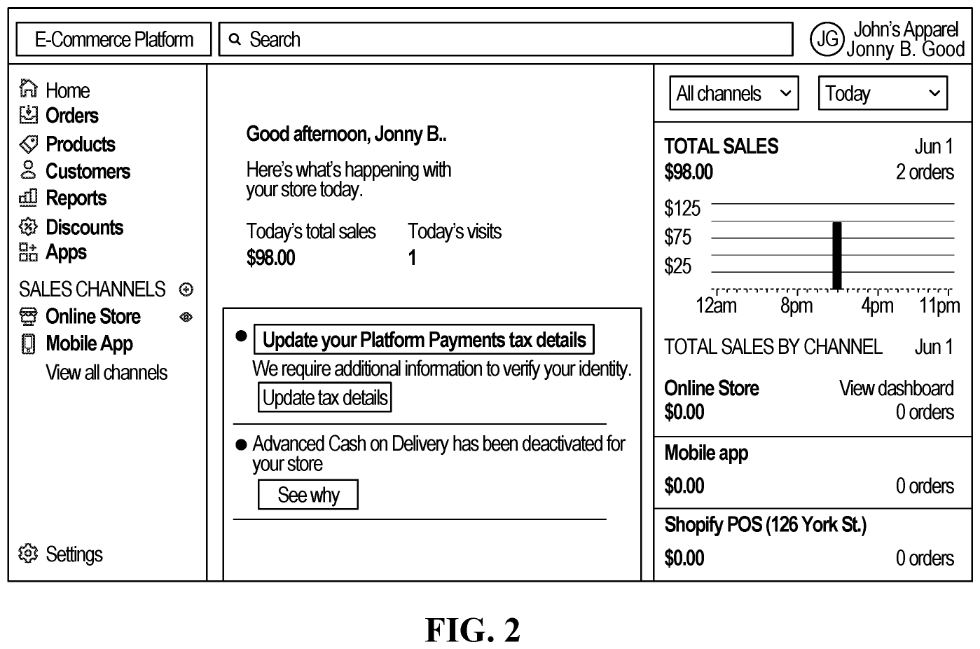

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's bank account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the platform 100 or by a different party. In some embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Personal Information in Software Instances

Some software instances that are implemented by the e-commerce platform 100 can display or otherwise provide personal information to users. For example, the administrator 114, the applications 142A-B, the commerce management engine 136, the services 116, the analytics 132 and/or the communication facility 129 can implement software instances that may display personal information during execution. This personal information can relate to any merchants and/or customers that use (for example, have accounts on) the e-commerce platform 100. Non-limiting examples of such personal information include names, addresses, contact information, transaction details, billing information, shipping information, information on products purchased and information on services rendered. Any, some or all of this personal information may be stored in the data facility 134. Personal information can include personally identifiable information (PII), which is information that allows a user to be identified.

As used herein, the term “software instance” relates to any form of computer-executable instructions, including websites, service instances, software applications and the like. Further, the terms “software instance”, “software”, “computer program” and “program” can be used interchangeably.

In some cases, an individual may be provided with access to a software instance or a certain aspect of a software instance from the e-commerce platform 100. This individual might not be an end user of the software instance, but may instead be a person involved in developing the software instance and/or supporting end users of the software instance. Providing an individual with access to a software instance might involve copying (or reproducing) at least an aspect of the software instance and providing this copy to the individual. It might also or instead involve providing an individual with an account to access the software instance on a remote server.

Examples of different situations where an individual is provided with at least an aspect of a software instance are described below. While these example situations may occur in the field of e-commerce, the example situations are in no way limited to e-commerce. The example situations may also occur in the banking and medical fields.

In a first example situation, during testing or use of a computer program, a user may discover a screen page that includes untranslated text. This screen page may be a webpage of a website, a screen/user interface page/panel of a software application, or a section of a web-based application or progress web application, for example. In some cases, the user could be interacting with the program in English and navigate to a screen page that lacks an English translation. After identifying this untranslated screen page, a copy of the screen page could be sent to a translator in order to obtain an English translation of the screen page. However, the translator might benefit from additional information regarding the program to provide context for translating the screen page. Providing the translator with only an image (for example, a screenshot) of the screen page to be translated might not provide enough information to remove any ambiguity for the purposes of translation. By way of example, the terms “enter”, “next”, and “continue” could all be used to label a button for directing a user from one screen page to another. The choice of which term is most appropriate can depend on the context of the program, such as the content that is displayed on the screen page linked to by the button, for example. Therefore, in some cases, the translator may be provided with a copy of the program (or at least part of the program) to allow the translator to interact with the program. This may provide the translator with appropriate context to produce more accurate translations.

In a second example situation, during testing or use of a computer program, a user may detect an error in the program. This error may be caused by the user performing a particular sequence of actions in the program that were not previously tested. A record of the actions that resulted in the error could be created and sent to a program developer for appropriate correction or “debugging”. This record of actions could be considered a copy of at least an aspect of the program, which the program developer can use to interact with the program in order to better identify the underlying issue causing the error.

In a third example situation, during use of a computer program, a user might become confused or otherwise require assistance. The user could contact a support person to help them navigate the issue. The support person might be remote from the user, but is able to access the same aspect of the computer program that the user is engaging with in order to better understand the issue. For example, the support person might have an account that enables them to access the user's account on the program. Being able to interact with the program in the same way as the user might allow the support person to better understand the source of the user's confusion and provide them with informed advice to troubleshoot the issue.

In the example situations described above, there is the potential that personal information, such as PII, could be shared with an individual. For example, when sharing a copy of a program with an individual or granting the individual access to a program, the individual might be able to view PII provided by the program. In particular, if an individual has access to a user's account within a program or is otherwise able to view content that is specific to a user's account, then that individual may have access to PII of the user.

In some cases, PII is a regulated type of information. Only certain individuals might have the authorisation to work with PII. This can create issues in certain situations within software development. For example, if a translator does not have authorization to work with PII, then the translator should not be sent any content that includes PII. This might limit the amount of context that a translator can obtain to guide their translation. Similarly, as a further example, if a software developer does not have authorization to work with PII, then the program developer should not have access to any aspect of a program that might include PII. This might hinder the software developer's ability to learn from errors encountered by users of a program. As a yet further example, if a support person does not have authorization to work with PII, then the support person should not have access to any aspect of a program that might include PII. This might hinder the support person's ability to understand a user's issue on the program.

Accordingly, a need exists for systems and methods to reduce an individual's exposure to PII when granting the individual access to a software instance.

In some embodiments, the e-commerce platform 100 of FIG. 1 is configured to modify software instances to remove personal information prior to those software instances being used by particular individuals. For example, when an individual needs to access a software instance that includes personal information but the individual does not have permission to view the personal information, then the e-commerce platform 100 can instead provide the individual with a modified version of the software instance with the personal information removed and optionally replaced. Non-limiting examples of individuals that might require access to a software instance but do not have permission to view any personal information in the software instance include translators, software developers and support personnel.

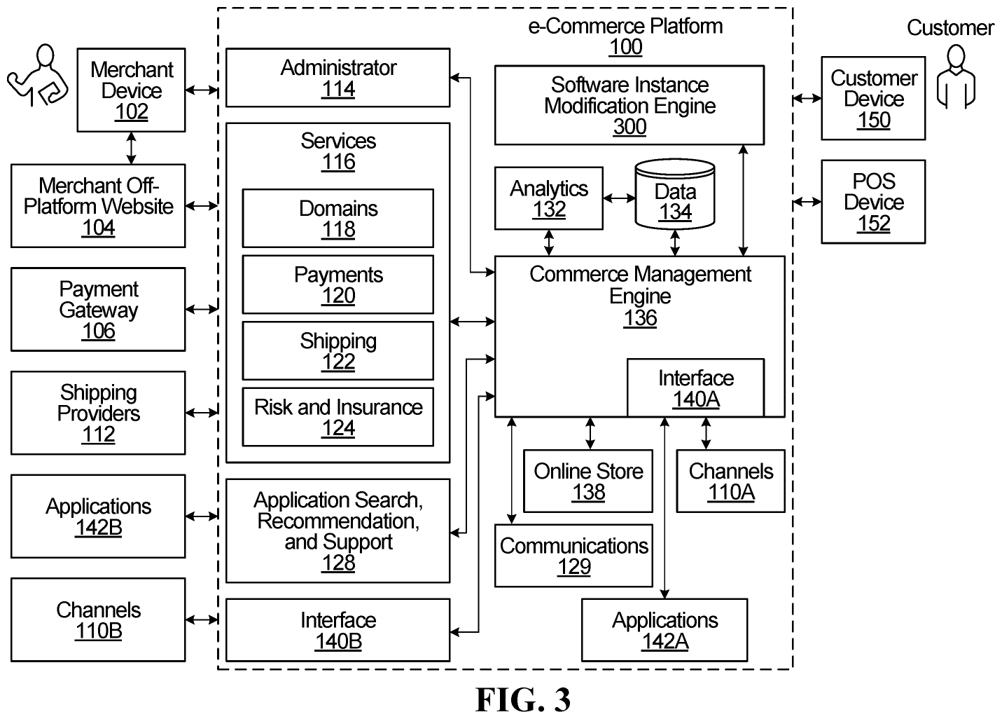

FIG. 3 illustrates the e-commerce platform 100 of FIG. 1, but including a software instance modification engine 300. The software instance modification engine 300 is an example of a computer-implemented system for obtaining software instances from other components of the e-commerce platform 100, identifying personal information in the software instances, modifying the software instances to remove and optionally replace the personal information, and storing the modified software instances. If a particular individual does not have the necessary permissions to access an original software instance that includes personal information, then the individual could instead be granted access to a modified version of the software instance. This individual might be a person involved in developing the e-commerce platform 100 and/or supporting end users of the e-commerce platform, for example. In some implementations, the e-commerce platform 100 configures certain user account permissions that trigger the removal of personal information from software instances. Modifying software instances in the e-commerce platform 100 to remove personal information can allow an unrestricted number of different individuals to access software instances on the e-commerce platform 100 without risking the disclosure of personal information to unauthorized individuals.

Although the software instance modification engine 300 is illustrated as a distinct component of the e-commerce platform 100 in FIG. 3, this is only an example. A software instance modification engine could also or instead be provided by another component of the e-commerce platform 100 or offered as a stand-alone component or service that is external to the platform 100. In some embodiments, the commerce management engine 136 provides a software instance modification engine. The e-commerce platform 100 could include multiple software instance modification engines that are provided by one or more parties. The multiple software instance modification engines could be implemented in the same way, in similar ways and/or in distinct ways. In addition, at least a portion of a software instance modification engine could be implemented on the merchant device 102. For example, the merchant device 102 could store and run the software instance modification engine locally as a software application.

The software instance modification engine 300 could implement at least some of the functionality described herein. Although the embodiments described below may be implemented in association with an e-commerce platform, such as (but not limited to) the e-commerce platform 100, the embodiments described below are not limited to the specific e-commerce platform 100 of FIGS. 1 to 3. Further, the embodiments described herein do not necessarily need to be implemented in association with or involve an e-commerce platform at all. Other computing platforms could implement the systems and methods disclosed herein. Examples of such computing platforms include healthcare platforms and banking platforms, to name but a few.

### Modifying Software Instances to Remove Personal Information

The present disclosure provides systems and methods for identifying and removing personal information provided by a software instance. Once the personal information has been removed, the resulting software instance can be provided to an individual that is not authorized to view personal information. For example, the software instance can be provided to a translator for translation of one or more screen pages, to a software developer for detection and correction of an error, and/or to a support person to help troubleshoot a user's issue.

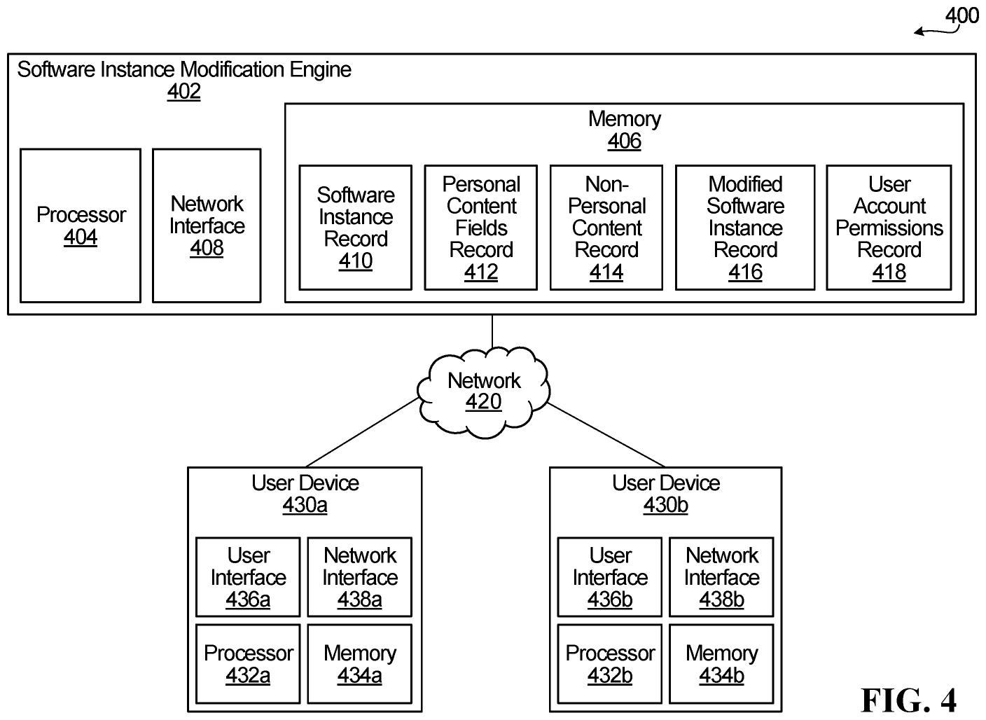

FIG. 4 is a block diagram illustrating an example system 400 for modifying software instances. The system 400 includes a software instance modification engine 402, a network 420, and multiple devices 430a, 430b.

The software instance modification engine 402 supports the modification of software instances to remove personal information. The location of the software instance modification engine 402 is implementation specific. In some implementations, the software instance modification engine 402 is provided at least in part by an e-commerce platform, either as a core function of the e-commerce platform or as an application supported by the e-commerce platform. For example, the software instance modification engine 402 could be the software instance modification engine 300 of FIG. 3. In some implementations, the software instance modification engine 402 is implemented as a stand-alone component or service that is external to the e-commerce platform or that is implemented at least in part by a user device. Other implementations of the software instance modification engine 402 are also contemplated. For example, the software instance modification engine 402 could be implemented in association with a banking platform or a healthcare platform. While the software instance modification engine 402 is shown as a single component, the software instance modification engine 402 could instead be provided by multiple different components that are in communication via the network 420, for example.

The software instance modification engine 402 includes a processor 404, memory 406 and a network interface 408. The processor 404 may be implemented by one or more processors that execute instructions stored in the memory 406. These instructions could implement any method described herein. Alternatively, some or all of the processor 404 may be implemented using dedicated circuitry, such as an application specific integrated circuit (ASIC), a graphics processing unit (GPU) or a programmed field programmable gate array (FPGA).

The network interface 408 is provided for communication over the network 420. The structure of the network interface 408 is implementation specific. For example, the network interface 408 may include a network interface card (NIC), a computer port (e.g., a physical outlet to which a plug or cable connects), and/or a network socket.

The memory stores a software instance record 410, a personal content fields record 412, a non-personal content record 414, a modified software instance record 416, and a user account permissions record 418.

The software instance record 410 includes copies of one or more original software instances, before any modification by the software instance modification engine 402. As noted above, a software instance generally includes computer-executable instructions, and may also be referred to as a “computer program” or simply a “program”. In some implementations, a software instance enables a process to be executed by a computer. The software instances stored in the software instance record 410 may implement or otherwise provide software services, applications and/or webpages, for example.

Some software instances include computer-executable instructions for generating one or more screen pages. Non-limiting examples of screen pages include webpages and graphical user interfaces. Screen pages can provide a user with a variety of content, including text, images, audio and/or video, for example. Screen pages can also include one or more action elements to enable certain functionality for the user. For example, a screen page can include one or more buttons that direct a user to other screen pages. In some cases, screen pages may display personal information and/or PII.

The software instances stored in the software instance record 410 may be obtained in any of a number of different ways. In some implementations, the software instances are received from another device, such as one of the devices 430a, 430b, for example. A software instance may be stored and/or run locally on one of the devices 430a, 430b, and be transmitted to the software instance modification engine 402 via the network 420. In some cases, one or both of the devices 430a, 430b might be, or form part of, a remote server that is running the software instance to provide a service. By way of example, a software instance running on a server may be implementing an online store on an e-commerce platform, a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and the like. Software instances running on a server may be licensed on a subscription basis and centrally hosted. For example, the software instances may be accessed by users using a client (for example, a thin client) via a web browser or other application, or be accessed by point of service (POS) devices.

When the software instance modification engine 402 is associated with a particular platform, such as an e-commerce, banking or healthcare platform, for example, the software instance record 410 could store any, some or all of the software instances that are implemented on the platform. The software instances could be added to the software instance record 410 by default. For example, any software instance that generates screen pages potentially containing personal information could be added to the software instance record 410 automatically.

In some implementations, a software instance is stored in the software instance record 410 for the specific purpose of removing personal information. For example, when a user without permission to view personal information requests access to a particular software instance, the software instance could be first transmitted to the software instance modification engine 402 and stored in the software instance record 410. The software instance could then be processed by the software instance modification engine 402 to detect and remove any personal information.

It should be noted that a software instance might not correspond to an entire website, service instance or software application. In some implementations, only a relevant aspect of a software application could be copied and stored in the software instance record 410. For example, an aspect of a software application could be generated by recording a series of actions performed by a user of the application and the resulting screen pages that were displayed to the user.

The personal content fields record 412 includes a list of predefined content fields that can potentially contain personal information such as PII, for example. These predefined content fields may be displayed in a screen page that is generated by a software instance, for example. The software instance modification engine 402 can use the personal content fields record 412 to determine which fields or areas of a screen page might include personal information. This can help facilitate the detection and identification of personal information in the screen page.

In general, a content field in a screen page can include any form of content, including text, images, videos and audio, for example. Non-limiting examples of content fields that can potentially include personal information, and may therefore be identified in the personal content fields record 412, include:
content fields that may contain a user's name or identification number (for example, a social security number);
content fields that may contain location associated with a user (for example, a user's home address);
content fields that may contain a date associated with a user (for example, a user's birthdate);
content fields that may contain financial information (for example, a user's credit card number);
content fields that may contain an image associated with a user;
content fields that may contain medical and/or biometric information; and
open text fields.

Predefined content fields may be identified in the personal content fields record 412 in any of a number of different ways. In some implementations, a list of keywords that relate to personal information are stored in the personal content fields record 412. Non-limiting examples of such keywords include the terms “name”, “address”, “date of birth”, and “credit card”. Any content fields in a screen page that include a keyword stored in the personal content fields record 412 may be considered a predefined type of content field that can potentially include personal information.

In some implementations, a list of predefined content field formats that relate to personal information are stored in the personal content fields record 412. Non-limiting examples of such content field formats include text fields having the format of a date, a name or a credit card number. Image, video and audio content fields may also be identified as content field formats that can relate to personal information. For example, an image, video and/or voice recording of a user may provide biometric information relating to the user that can constitute PII. Further, user input fields may be identified as content field formats that can include user provided personal information. Non-limiting examples of user input fields include open text fields, drop down menus, and image/audio/video upload fields.

The non-personal content record 414 includes non-personal, dummy or generic content that can be used to replace or mask personal information in a screen page. This non-personal content could be considered placeholder content to maintain the general layout of a screen page after any personal information has been removed. The form of the non-personal content stored in the non-personal content record 414 is not limited herein.

In some implementations, the non-personal content record 414 may store random or meaningless content. For example, Lorem ipsum text or a Lorem ipsum text generator could be used to replace any textual content in a screen page.

In some implementations, the non-personal content record 414 may store content that can maintain the context of original personal information. For example, the non-personal content record 414 may store a list of fictional names, addresses, dates and credit card numbers that can replace corresponding types of personal information in a screen page. Generic images, videos and audio can also be stored in the non-personal content record 414. In some cases, the non-personal content record 414 may store contextually valid content that can be used to replace any, one, some or all of the predefined content fields identified in the personal content fields record 412. As such, when a predefined content field that may contain personal information is detected in a screen page, non-personal content that corresponds to this predefined content field may be obtained from the non-personal content record 414.

The modified software instance record 416 stores software instances that have been modified to remove and optionally replace any personal information. Example methods for modifying software instances are provided elsewhere herein. In some implementations, for each software instance stored in the software instance record 410, there is a corresponding version of the software instance stored in the modified software instance record 416. Alternatively, a software instance might only be modified to remove personal information as needed, for example when a user without permission to access personal information requests access to the software instance. Therefore, only some of the original software instances in the software instance record 410 may have a corresponding version stored in the modified software instance record 416.

The user account permissions record 418 identifies which users have access to personal information and which users do not. This can help determine the users that are granted access to original software instances and the users that are instead granted access to modified software instances. A user that requests access to a particular software instance may be provided with the original software instance from the software instance record 410 or the modified software instance from the modified software instance record 416 based on their permissions to view personal information.

When the software instance modification engine 402 is associated with a particular platform, such as an e-commerce, banking or healthcare platform, for example, the user account permissions record 418 could include a set of permissions for each user of the platform. In some implementations, specific permissions could be provided for certain individuals involved in the development of a platform, such as translators, software developers and support personnel, for example. Having these permissions can provide an individual with access to any, some or all of the software instances stored in the modified software instance record 416, which can allow the individual to perform their functions without risking their exposure to personal information.

The devices 430a, 430b are in communication with the software instance modification engine 402 via the network 420. The devices 430a, 430b may provide software instances for storage in the software instance record 410, and/or obtain modified software instances from the modified software instance record 416. Either or both of the devices 430a, 430b might be user devices that are associated with a particular individual or might be devices that are implemented as a server.

The devices 430a, 430b might have different levels of access to personal information. In one example, the device 430a might be associated with a user that is accessing personal information from their account on an e-commerce platform. If this user encounters a problem, such as an untranslated page or a software bug, for example, then another individual associated with the device 430b might be employed to assist the user with the problem. The other individual might not have permission to view the personal information on the user's account, and therefore the device 430b would receive a modified version of the user's account having the personal information removed and optionally replaced.

The device 430a includes a processor 432a, memory 434a, user interface 436a and network interface 438a. Similarly, the device 430b includes a processor 432b, memory 434b, user interface 436b and network interface 438b. The device 430a will be described by way of example below. However, it should be noted the description of the device 430a can also apply to the device 430b.

The user interface 436a can include, for example, a display screen (which may be a touch screen), a gesture recognition system, a speaker, headphones, a microphone, haptics, a keyboard, and/or a mouse. The network interface 438a is provided for communicating over the network 420. The structure of the network interface 438a will depend on how the device 430a interfaces with the network 420. For example, if the device 430a is a mobile phone, headset or tablet, then the network interface 438a may include a transmitter/receiver with an antenna to send and receive wireless transmissions to/from the network 420. If the user device is a personal computer connected to the network with a network cable, then the network interface 438a may include, for example, a NIC, a computer port, and/or a network socket. The processor 432a directly performs or instructs all of the operations performed by the device 430a. Examples of these operations include processing user inputs received from the user interface 436a, preparing information for transmission over the network 420, processing data received over the network 420, and instructing a display screen to display information. The processor 432a may be implemented by one or more processors that execute instructions stored in the memory 434a. Alternatively, some or all of the processor 432a may be implemented using dedicated circuitry, such as an ASIC, a GPU, or a programmed FPGA.

In FIG. 4, two devices are shown by way of example. More than two user devices may be in communication with the software instance modification engine 402.

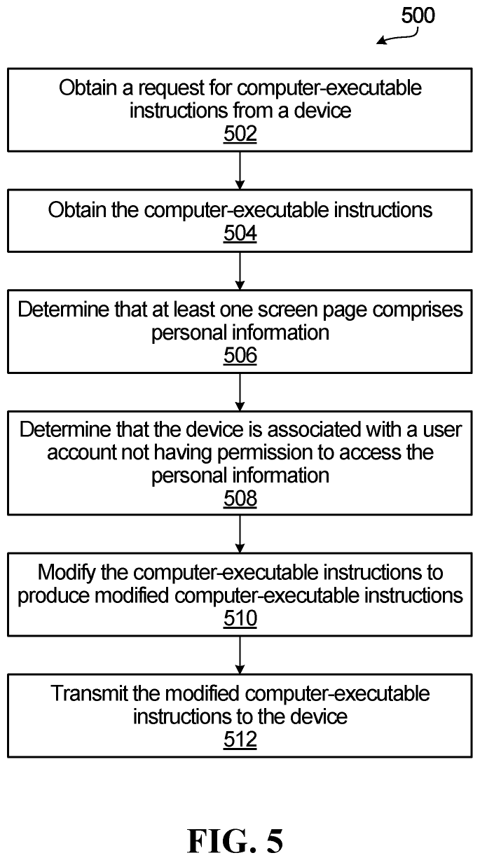

FIG. 5 is a flow diagram illustrating a method 500 for modifying software instances, according to an embodiment. The method 500 will be described as being performed by the software instance modification engine 402 of FIG. 4. However, other implementations are also contemplated. For example, the method 500 could be performed in whole or in part on one of the devices 430a, 430b.

Step 502 is an optional step that includes the processor 404 obtaining a request for computer-executable instructions from the device 430a. When executed, these computer-executable instructions are capable of generating a plurality of screen pages for display on the user interface 436a. The computer-executable instructions can also generate action elements that allow a user of the device 430a to navigate between the plurality of screen pages. By way of example, buttons or links embedded in the screen pages could allow a user to navigate between the screen pages using the user interface 436a.

When executed by a processor, the computer-executable instructions requested in step 502 may provide a website, service instance, software application or the like. However, in some cases, the computer-executable instructions might provide only part of a website, service instance or software application. For example, the screen pages that are generated by the computer-executable instructions may be only some of the screen pages that are provided by a website. As such, step 502 is not limited to computer-executable instructions that provide an entire website, service instance or software application.

In some implementations, the request obtained in step 502 is generated when (e.g., in response to) a user of the device 430a requests access to a software instance or part of a software instance. For example, the user of the device 430a might be a translator, software developer and software support personnel requesting access to a particular software instance to perform their function. Examples of different situations where a user might request access to at least an aspect of a software instance are described elsewhere herein.

Step 504 includes the processor 404 obtaining the computer-executable instructions requested in step 502. In some cases, the computer-executable instructions are obtained from the software instance record 410. The computer-executable instructions can also or instead be obtained from the device 430b via the network 420. For example, the user of the device 430a may request access to the same software instance that the user of the device 430b is interacting with. This might be the case when the user of the device 430a is a translator, software developer or support personnel that intends to correct a problem experienced by the user of the device 430b.

In some implementations, step 504 includes obtaining a record of the computer-executable instructions being executed on the device 430b. For example, the user of the device 430b could perform a series of actions on a website that result in the presentation of multiple screen pages. The cookies and browsing history stored on the device 430b are examples of a record of the execution of the computer-executable instructions for generating the screen pages. At some point, the user might encounter a problem on the website. The cookies and/or browsing history could then be transmitted to the software modification engine 402, which allows the processor 404 to determine the series of actions that led to the problem. From this series of actions, the processor 404 can obtain computer-executable instructions that generate the multiple screen pages. These computer-executable instructions may be stored, at least temporarily, as a software instance in the software instance record 410.

Step 506 includes the processor 404 determining that at least one screen page (of the plurality of screen pages generated by the computer-executable instructions obtained in step 504) includes personal information. The personal information may include, inter alia, a name, a location, a date, an identification number, financial information, medical information and/or biometric information. In some cases, at least some of the personal information is PII. If the computer-executable instructions are obtained from the device 430b, then the personal information may correspond to a user of the device 430b. However, more generally, the personal information can correspond to any person or group of people.

Example manners of determining that a screen page includes personal information will now be discussed.

It is noted that a screen page may be composed of one or more user interface elements. For example, user interface elements may include one or more of buttons, labels, text fields, scrollbars, check boxes, and/or drop-down boxes.

In some implementations, identification of personal information may be reliant on or based on metadata associated with portions of the computer-executable instructions. For example, the computer-executable instructions for rendering a particular user interface element may be associated with metadata identifying user interface elements that are expected to or may contain/render personal information. In this way, user interface elements may be tagged as being associated with personal information. In some implementations, such metadata in the computer-executable instructions may correspond to metadata (e.g., other tags) included in source code from which the computer-executable instructions are derived such as, for example, where the computer-executable instructions are object or bytecode derived from source code written in a high-level programming language. In another example, it may be that user interface elements are assumed to include personal information unless affirmatively tagged as not containing such. Notably such an embodiment may be more robust against mistakes in software development/metadata authoring. For example, a failure to tag a user interface element may result in spurious masking of non-personal information rather than an unintended disclosure of private information where tagging is relied upon to flag elements that include personal information. In this way, privacy protection and prevention of unintended disclosure may be enhanced.

Additionally or alternatively, identifying elements of a screen page including personal content may include the processor 404 extracting one or more content fields from the plurality of screen pages and comparing the content fields and a list of predefined content fields stored in the personal content fields record 412. If a content field matches one of the predefined content fields, then this content field and the corresponding screen page may be determined to include personal information. The comparison operation may include text analysis, image analysis and/or audio analysis of the content fields in the plurality of screen pages.

In one example, the personal content fields record 412 stores a list of terms that indicate the presence of personal information. Text analysis can be performed to extract words from the content fields in the plurality of screen pages. The extracted words can then be compared to the list of terms in the personal content fields record 412, and any word that matches a term in the list may indicate that the corresponding content field includes personal information.

In another example, the personal content fields record 412 stores a list of predefined content field formats that may indicate the presence of personal information. These predefined content field formats can include, inter alia, user input fields, text fields, image fields, audio fields and/or video fields. For example, any text fields that have the format of a name, location, date, identification number and/or financial number might include personal information. In the case that image field formats and/or video field formats are detected in a screen page, image analysis may be performed to determine if images of a user's face are present. For example, facial recognition could detect potential facial features that might constitute biometric information. Similar comments apply to audio field formats. Audio analysis could be performed on an audio field to determine if a user's voice is present, which might also constitute biometric information.

Notably, some manners of identifying personal information may be considered probabilistic; that is, likely to identify portions of screen pages including personal information, with some degree of confidence. For example, the above-discussed techniques for identifying fields likely to contain personal information may be considered probabilistic insofar as they could fail to identify some fields are containing personal information, especially if insufficiently tuned/not configured in a sufficiently conservative manner. In another example, machine learning techniques could, if employed to identify screen pages containing personal information, be considered probabilistic. In a particular example, if machine learning is employed to train a classifier intended to identify screen pages containing personal information, the results of applying that classifier may determine whether a given screen page includes personal information. However, pages would only be identified as containing or not containing personal information with some confidence that, in at least some cases, will be less than 100%—e.g., the best that can be determined using such methods will, in at least some cases, be that a page (and more particularly an element thereof) “probably” does or does not include personal information.

In some cases, it may be desirable to avoid reliance on such probabilistic methods alone due to the possibility of a misclassification leading to an unintended disclosure of personal information. Such concerns may be particularly paramount, for example, for particular forms/types/classes of personal information with heightened privacy concerns associated therewith such as, for example, medical information. For example, a failure of a probabilistic method to identify medical information and/or other sensitive personal information as personal information may result in an unintended disclosure. Notably, in at least some jurisdictions, inadvertent disclosure of such sensitive information could potentially lead to legal liability.

Notably, however, such probabilistic techniques may be employed in combination with prescriptive methods—such as, for example, methods reliant on metadata identifying user interface elements as do/may contain personal information as discussed above—in order to provide a backstop. For example, where metadata is used to identify fields/user interface elements as containing (or not containing) personal information, one or more probabilistic methods may also be employed in case fields containing personal information are inadvertently not identified as such. In a particular example, where user interface elements (e.g. fields) are tagged as not-containing personal information, one or more probabilistic methods may be applied to those elements (and/or contents thereof) and, if the probabilistic method nonetheless identifies/classifies the element as containing personal information, then the user interface element may be nonetheless treated as containing personal information despite it being tagged as not-containing such (and/or not being tagged as containing personal information, depending on the nature of the metadata/tagging in a given implementation). In this way, probabilistic methods may, despite their possible less than perfect reliability in identifying personal information, be used to enhance the identification thereof and/or to lessen the likelihood of an unintended disclosure of personal information. Additionally or alternatively, probabilistic techniques may be employed in concert with techniques such as metadata/tagging at an earlier stage than the actual modifying of a user interface. For example, it may be that a tool is provided whereby a probabilistic technique can be applied to a user interface in order to facilitate validation/entry of metadata/tags. In a particular example, such a tool could identify fields that, based on the use of the probabilistic technique, are flagged as not containing personal information (or alternatively not flagged as containing personal information) and/or vice-versa, and those fields so identified may then be presented to a user as warnings of possible incorrect tagging and/or suggestions of addition metadata to add to the user interface.

Referring again to step 506 of the method 500, this step may include determining that particular elements (for example, one or more user interface elements) of at least one screen page of the plurality of screen pages include personal information. As outlined above, such a determination may be based, at least in part, on metadata associated with elements of screen pages of the plurality of screen pages. The determination may also or instead be based on at least one probabilistic technique. For example, in some implementations, step 506 includes identifying, based on the metadata associated with the elements of the plurality of screen pages, a first subset of elements of the at least one screen page including personal information. This first subset of elements may include one or more elements that have been tagged with metadata indicating an association with personal information, for example. Alternatively or additionally, step 506 may include identifying, using at least one probabilistic technique, at least one further element of the at least one screen page not in the first subset of elements and considered likely to also comprise personal information. In this way, the at least one probabilistic technique may provide a degree of redundancy to help ensure that the first subset of elements does not exclude an element of the at least one screen page that includes personal information. The particular elements determined to include personal information in step 506 may therefore be the elements of the first subset of elements and the at least one further element.

Step 508 is an optional step that includes the processor 404 determining that the device 430a, which requested access to the computer-executable instructions, is associated with a user account not having permission to access personal information. As noted above, the device 430a could be used by a translator, software developer or software support person that does not have permission to view personal information. In some implementations, step 508 includes searching the user account permission record 418 for the user account associated with the device 430a. The user account permission record 418 may indicate that the user account does not have permission to access the personal information.

Following step 508, the software instance modification engine 402 has determined that the user of the device 430a should not be provided with the original computer-executable instructions requested in step 502, and should instead be provided with a modified version of the computer-executable instructions that do not provide personal information.

Step 510 includes the processor 404 modifying the original computer-executable instructions obtained in step 504 to produce modified computer-executable instructions. These modified computer-executable instructions may provide a modified software instance, for example. The screen pages that are generated by the original computer-executable instructions and that do not include personal information can also be generated by the modified computer-executable instructions. However, the screen pages identified in step 506 as containing personal information would not be generated by the modified computer-executable instructions. Instead, the modified computer-executable instructions generate modified screen pages that correspond to screen pages identified in step 506, but with the personal information removed. The other content in the screen pages identified in step 506 (i.e., the content that does not include personal information) can be maintained in the modified screen pages. In some cases, the modified screen pages could be considered re-renders of the original screen pages. In summary, at step 510, the processor 404 may modify the original computer-executable instructions obtained in step 504 to not, when executed, generate screen pages including personal information, the modification yielding the modified computer-executable instructions.

The personal information present in the screen pages generated by the original computer-executable instructions may be deleted, removed, scrambled or redacted in the modified screen pages. In some implementations, the personal information is also (or instead) masked or replaced with non-personal information in the modified screen pages. In these implementations, step 510 can include the processor 404 obtaining non-personal content that corresponds to the personal information in the original screen pages. The modified screen pages generated by the modified computer-executable instructions can then include this non-personal content in place of the personal information. The non-personal content may be selected to maintain the general context of the original screen page. For example, if a screen page includes a user's address, then a corresponding modified screen page could replace the user's address with a generic address. An individual that is viewing the modified screen page may therefore better appreciate the context of the original screen page from the modified screen page.

The non-personal content could be retrieved from memory, such as from the non-personal content record 414, for example. Alternatively, the non-personal content could be generated by the software instance modification engine 402 based on the content in the original screen pages. Machine learning, for example, could be used in the active generation of non-personal content.

In some implementations, if it is determined in step 506 that that particular elements of at least one screen page of the plurality of screen pages include personal information, then the modified computer-executable instructions obtained in step 510 may generate at least one modified screen page that corresponds to the at least one screen page having the particular elements of the at least one screen page replaced with corresponding elements including non-personal content corresponding to the personal information.

As noted above, the plurality of screen pages generated by the original computer-executable instructions can include action elements to navigate between the screen pages. In some implementations, the modified computer-executable instructions also generate the same or similar action elements to navigate between the screen pages generated by the modified computer-executable instructions. Thus, the actions that can be performed with the modified computer-executable instructions may be substantially the same as the actions that can be performed with the original computer-executable instructions. This may allow the context, look, feel, and behavior provided by the original computer-executable instructions to be substantially maintained in the modified computer-executable instructions. An individual using the modified computer-executable instructions may have a better understanding of the context, function and operation of the original computer-executable instructions, which could aid in translation, debugging and troubleshooting, for example. In contrast, if an individual were simply sent an image or video of a screen page for the purpose of translation, debugging or troubleshooting, then the individual might be hindered by an inability to discern the context of the screen page from the image or video.

Following step 510, the modified computer-executable instructions may be stored in the modified software instance record 416.

Step 512 includes transmitting the modified computer-executable instructions to the device 430a. When executed by the device 430a, the modified computer-executable instructions can display (e.g., is adapted to display) any of the original screen pages that do not include personal information and the modified screen pages that have had the personal information removed and optionally replaced. Other content, such as non-personal audio content, can also be presented at the device 430a when the modified computer-executable instructions are executed. In some implementations, the device 430a is used by a translator for translation of one or more screen pages, a software developer for detection and correction of an error, or a support person to help troubleshoot a user's issue.

The method 500 provides one embodiment in which modified versions of computer-executable instructions are generated after receiving a request to access the computer-executable instructions. However, in some embodiments, the steps of the method 500 may be performed in other orders. For example, steps 504, 506, 510 may be performed before steps 502, 508, 512. This may be the case when software instances are automatically analysed and modified to remove personal information. When a user requests access to a particular software instance, the permissions of that user's account can dictate whether the user receives the original software instance (from the software instance record 410, for example) or a modified version of the software instance (from the modified software instance record 416, for example).

Furthermore, while the method 500 includes a single step 510 of modifying the computer-executable instructions, this could instead be done in multiple steps and/or in real-time. In some cases, when a user without access to view personal information is navigating the screen pages of a software instance, computer-executable instructions could be obtained for one screen page at a time. Each screen page can then be analysed for personal information and the corresponding computer-executable instructions can be modified, as appropriate, in real-time.

### Further Examples of Modifying Software Instances to Remove Personal Information

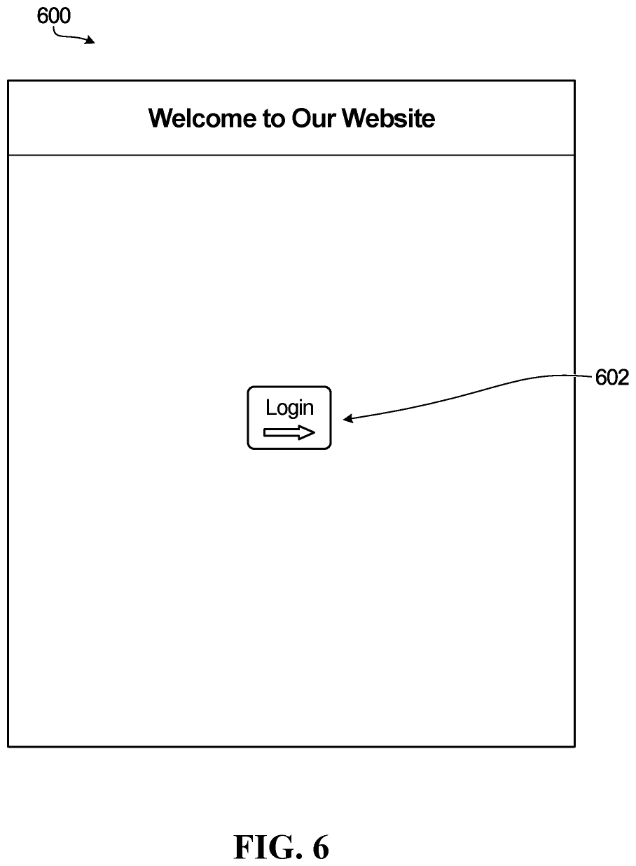

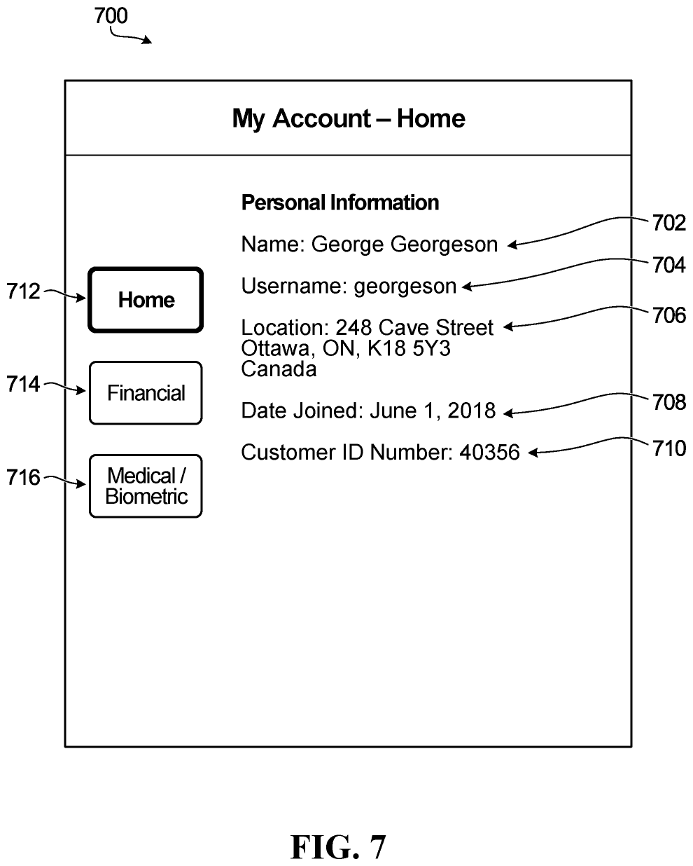

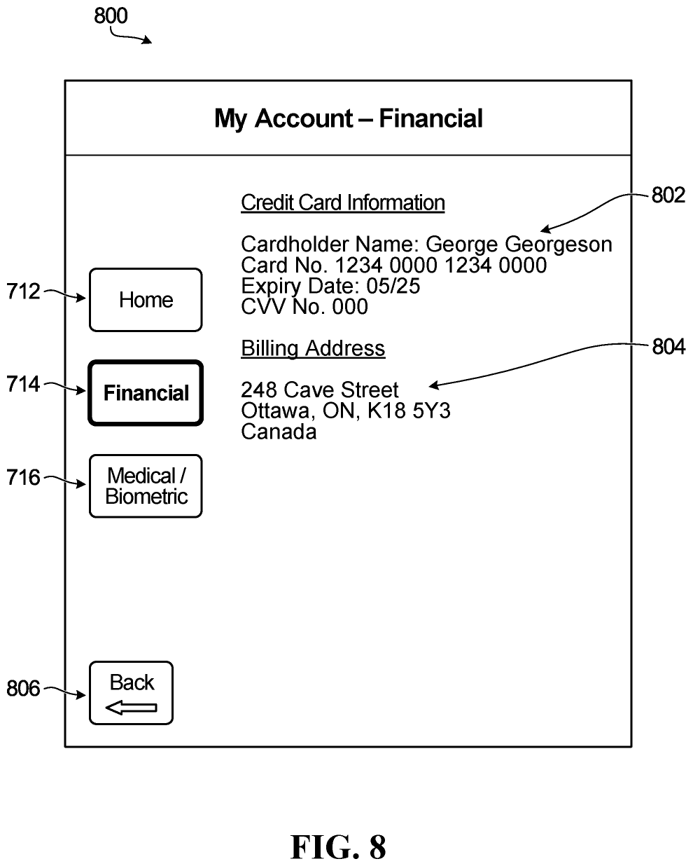

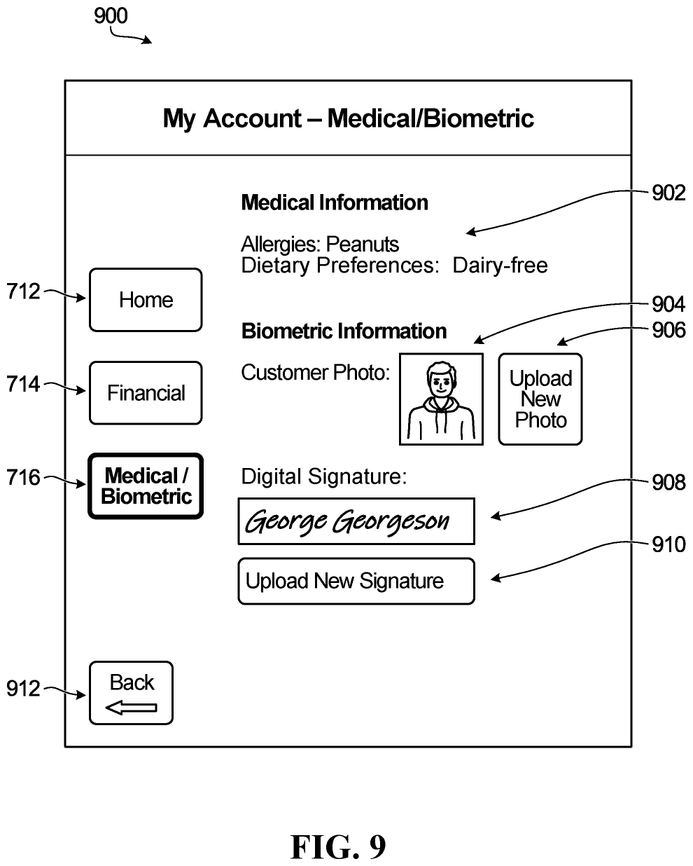

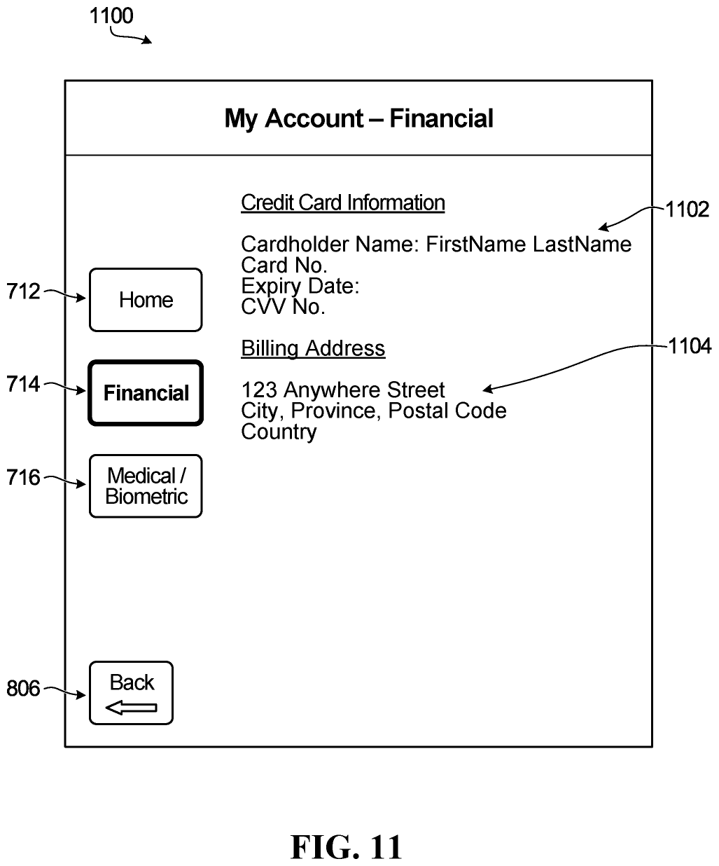

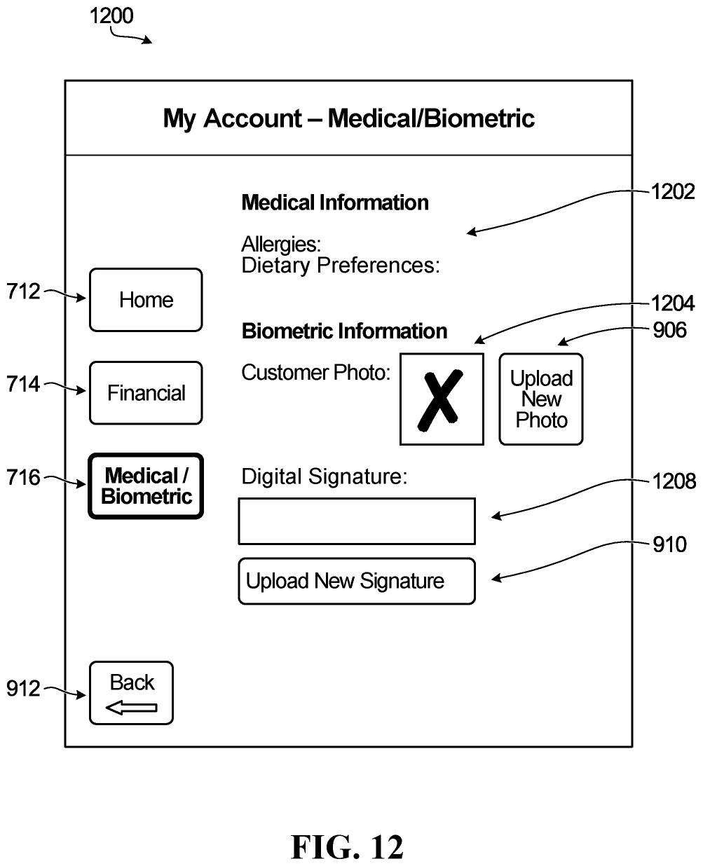

Reference will now be made to FIGS. 6 to 13, which provide an example of modifying a software instance to remove personal information. FIGS. 6 to 9 illustrate multiple screen pages 600, 700, 800, 900, respectively, that are generated by an original or unmodified software instance. The screen pages 600, 700, 800, 900 correspond to a user's account on a website that could be hosted by an e-commerce, banking or medical platform, for example.

The screen page 600 provides a welcome page for the website, including a button 602 that allows a user to login to their account. After selecting the button 602, the user can enter their login information and be directed to the screen page 700. The screen page 700 could be considered a home page of the user's account. The screen page 700 displays multiple content fields 702, 704, 706, 708, 710 that include personal information corresponding to the user. The content field 702 includes the user's name, the content field 704 includes a username for the user's account, the content field 706 includes the user's address, the content field 708 includes the date the user created their account, and the content field 710 includes the user's customer identification (ID) number on the platform hosting the website.

The screen page 700 further includes multiple buttons 712, 714, 716 for navigating between the screen pages 600, 700, 800, 900. Selection of the button 712 directs the user to the screen page 700, selection of the button 714 directs the user to the screen page 800 and selection of the button 716 directs the user to the screen page 900.

The screen page 800 provides financial information associated with the user. A content field 802 showing the user's credit card information and a content field 804 showing the user's billing address are both displayed on the screen page 800. The content fields 802, 804 include examples of personal financial information. The screen page also includes a button 806 to direct the user back to the previous screen page. For example, if the user arrived at the screen page 800 by selecting the button 714 on the screen page 700, then selection of the button 806 would direct the user back to the screen page 700. The screen page 800 further includes the buttons 712, 714, 716 for navigating between the screen pages 600, 700, 800, 900.

The screen page 900 provides medical and biometric information pertaining to the user. The screen page 900 includes multiple content fields 902, 904, 908. The content field 902 displays the user's allergies and dietary preferences, the content field 904 displays a photograph of the user, and the content field 908 displays a digital signature of the user. The user's allergies and dietary preferences are examples of medical information. The photograph of the user and the digital signature of the user are examples of biometric information. As such, the content fields 902, 904, 908 can include personal information. The screen page 900 also includes a button 906 to upload a new photograph of the user, and a button 910 to upload a new digital signature for the user. The screen page 900 further includes a button 912 to direct the user back to the previous screen page and the buttons 712, 714, 716 for navigating between the screen pages 600, 700, 800, 900.

It should be noted that the content fields 702, 704, 706, 708, 710, 802, 804, 902, 904, 908 are examples of elements of the screen pages 700, 800, 900 that include personal information.

According to one embodiment, the software instance that generates the screen pages 600, 700, 800, 900 is modified using the method 500 of FIG. 5 to remove personal information. The method 500 may begin by receiving, in step 502, a request for the software instance from an individual.

In step 504, it is determined which of the screen pages 600, 700, 800, 900, and which of the content fields in the screen pages 600, 700, 800, 900, include personal information. The content in the screen page 600, including the button 602, does not relate to personal information. However, the content fields 702, 704, 706, 708, 710, 802, 804, 902, 904, 908 all include potentially personal information. In some implementations, text analysis is performed to determine that the content fields 702, 704, 706, 708, 710, 802, 804, 902, 904, 908 relate to names, locations, dates, identification numbers, financial information, medical information and biometric information. Further, image analysis could be performed to determine that the content field 904 includes a photograph of the user and the content field 908 includes a digital signature of the user. Thus, the screen pages 700, 800, 900 would be identified as containing personal information in the step 504.

Because the screen pages 700, 800, 900 contain personal information, step 506 is performed to determine if the individual that requested access to the software instance in step 502 has authorization to view personal information. If the individual does have access to personal information (for example, if the individual is the user associated with the user account), then the individual could be provided with access to the original software instance from a remote server, for example. Alternatively, if the individual does not have access to personal information (for example, if the individual is a translator, software developer or software support personnel), then the individual could be provided with access to a modified software instance from a remote server. The modified software instance could be generated in step 510 and be provided to the individual in step 512.

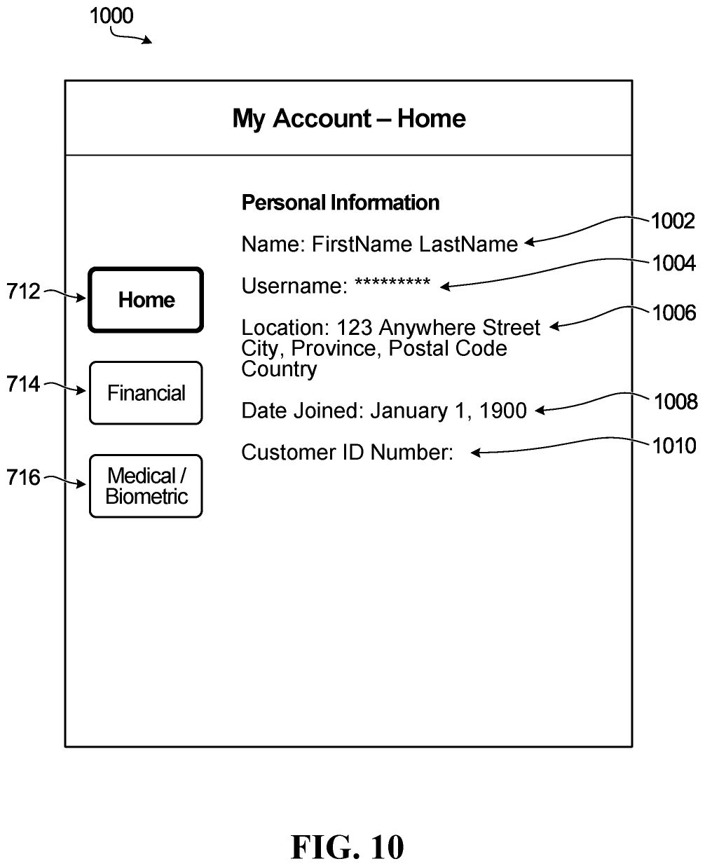

FIGS. 10 to 12 illustrate multiple screen pages 1000, 1100, 1200, respectively, that are generated by the modified software instance. The screen pages 1000, 1100, 1200 generally correspond to the screen pages 700, 800, 900, but with the personal information removed and, in some cases, replaced. Because the screen page 600 does not include any personal information, the screen page 600 does not have to be modified to avoid the disclosure of personal information to the individual. Therefore, the modified software instance still generates the screen page 600.

Compared to the screen page 700, the screen page 1000 has been modified as follows:
The content field 702 has been replaced with the content field 1002. The content field 1002 includes a non-personal name in place of the name of the user. This non-personal name is an example of contextually valid non-personal information.
The content field 704 has been replaced with the content field 1004, which includes a redacted username of the user.
The content field 706 has been replaced with the content field 1006. The content field 1006 includes a non-personal address in place of the user's address. This is another example of personal information being replaced with contextually valid non-personal information.
The content field 708 has been replaced with the content field 1008. The content field 1008 includes a random date in place of the date that the user created their account. This random date is a further example of contextually valid non-personal information.
The content field 710 has been replaced with the content field 1010, which has the ID number of the user removed.

Compared to the screen page 800, the screen page 1100 has been modified as follows:
The content field 802 has been replaced with the content field 1102. In the content field 1102, a non-personal name is used in place of the user's name, but the other information related to the credit card information has been removed.
The content field 804 has been replaced with the content field 1104, which includes a non-personal address.

Compared to the screen page 900, the screen page 1200 has been modified as follows:
The content field 902 has been replaced with the content field 1202. The content field 1202 has removed the details of the user's allergies and dietary preferences.
The content field 904 has been replaced with the content field 1204, which includes a redacted photograph of the user. As such, no facial features of the user are included in the screen page 1200.
The content field 908 has been replaced with the content field 1208, in which the digital signature of the customer is removed.

The content in the screen pages 700, 800, 900 that does not include personal information is maintained in the screen pages 1000, 1100, 1200. This includes some of the text in the content fields 702, 704, 706, 708, 710, 802, 804, 902, 904, 908, 1202, 1204, 1208, such as the headings, for example. The buttons 712, 714, 716, 806, 906, 910, 912 are also maintained in the screen pages 700, 800, 900, which can allow an individual to navigate between the screen pages 600, 1000, 1100, 1200 in a similar manner to how the user would navigate between the screen pages 600, 700, 800, 900. Further, the screen pages 1000, 1100, 1200 substantially maintain the formatting and style of the screen pages 700, 800, 900. Accordingly, the screen pages 1000, 1100, 1200 and the screen pages 700, 800, 900 might be considered to only differ by the presence of personal information. A person without authorization to view personal information can use the screen pages 600, 1000, 1100, 1200 generated by the modified software instance to understand the function and context of the screen pages 600, 700, 800, 900 generated by the original software instance.

The subject-matter of the present application may be applied in a variety of contexts. For example, it may be applied in collaboration scenarios such as, for example, when a first person is collaborating with a second person via video conferencing and/or the like. In a particular example, a software professional could be collaborating with a translator. It may be that the second person is not permitted to view personal information. This could, for example, be the case if the second person is external to an organization with which the first person is associated (e.g. the second person is an external contractor of the first person's employer) and appropriate non-disclosure/confidentiality agreements are not in place. Alternatively, it may be that, while appropriate confidentiality/contractual restrictions are in place, there may nonetheless be a desire to minimize the exposure of personal information to the second person such as, for example, due to the risks nonetheless of a breach occurring if the second person discloses the person information contrary to restrictions. In either case, the subject matter of the present application may be employed to, where the first person shares one or more screen pages with the second person as a part of collaborating with the second person (e.g., by the first person sharing their screen or a portion thereof such as in a video conference), mask personal information in the screen page(s) shared in their collaboration session (e.g., a video conference) so as to minimize/limit disclosure of personal information to the second person.

### CONCLUSION

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A computer-implemented method comprising:
obtaining computer-executable instructions for generating a plurality of screen pages;
determining, based on metadata associated with elements of screen pages of the plurality of screen pages, that particular elements of at least one screen page of the plurality of screen pages comprise personal information;
modifying the computer-executable instructions to produce modified computer-executable instructions, the modified computer-executable instructions being to generate at least one modified screen page that corresponds to the at least one screen page having the particular elements of the at least one screen page replaced with corresponding elements including non-personal content corresponding to the personal information; and
transmitting the modified computer-executable instructions to a device.

2. The computer-implemented method of claim 1, wherein modifying the computer-executable instructions comprises retrieving the non-personal content from memory.

3. The computer-implemented method of claim 1, wherein modifying the computer-executable instructions comprises generating the non-personal content based on the plurality of screen pages.

4. The computer-implemented method of claim 1, wherein when executed by the device, the modified computer-executable instructions are to display the at least one modified screen page and to display the screen pages of the plurality of screen pages other than the at least one screen page.

5. The computer-implemented method of claim 4, wherein:
the computer-executable instructions are to generate action elements to navigate between the plurality of screen pages; and
the modified computer-executable instructions are to generate the action elements to navigate between the at least one modified screen page and the screen pages of the plurality of screen pages other than the at least one screen page.

6. The computer-implemented method of claim 1, wherein the determination that particular elements of the at least one screen page comprise personal information is further based on a comparison between a content field in the at least one screen page and a list of predefined content fields stored in memory.

7. The computer-implemented method of claim 1, wherein determining, based on metadata associated with elements of screen pages of the plurality of screen pages, that particular elements of the at least one screen page comprise personal information comprises:
identifying, based on the metadata associated with the elements of the plurality of screen pages, a first subset of elements of the at least one screen page comprising personal information; and
identifying, using at least one probabilistic technique, at least one further element of the at least one screen page not in the first subset of elements and considered likely to also comprise personal information,
wherein the particular elements determined to comprise personal information are the elements of the first subset of elements and the at least one further element.

8. The computer-implemented method of claim 1, wherein:
the device is a first device; and
obtaining the computer-executable instructions comprises obtaining a record of the computer-executable instructions being executed on a second device.

9. The computer-implemented method of claim 1, further comprising:
prior to transmitting the modified computer-executable instructions to the device, determining that the device is associated with a user account not having permission to access the personal information.

10. The computer-implemented method of claim 1, wherein the personal information comprises at least one of a name, a location, a date, an identification number, financial information, medical information and biometric information.

11. The computer-implemented method of claim 1, wherein transmitting the modified computer-executable instructions to the device comprises transmitting the modified computer-executable instructions to a translator to translate text in the plurality of screen pages.

12. A system comprising:
memory to store computer-executable instructions for generating a plurality of screen pages; and
at least one processor to:
determine, based on metadata associated with elements of screen pages of the plurality of screen pages, that particular elements of at least one screen page of the plurality of screen pages comprise personal information;
modify the computer-executable instructions to produce modified computer-executable instructions, the modified computer-executable instructions being to generate at least one modified screen page that corresponds to the at least one screen page having the particular elements of the at least one screen page replaced with corresponding elements including non-personal content corresponding to the personal information; and
transmit the modified computer-executable instructions to a device.

13. The system of claim 12, wherein the at least one processor is further to retrieve the non-personal content from memory.

14. The system of claim 12, wherein the at least one processor is further to generate the non-personal content based on the plurality of screen pages.

15. The system of claim 12, wherein when executed by the device, the modified computer-executable instructions are to display the at least one modified screen page and to display the screen pages of the plurality of screen pages other than the at least one screen page.

16. The system of claim 15, wherein:
the computer-executable instructions are to generate action elements to navigate between the plurality of screen pages; and
the modified computer-executable instructions are to generate the action elements to navigate between the at least one modified screen page and the screen pages of the plurality of screen pages other than the at least one screen page.

17. The system of claim 12, wherein:
the memory is further to store a list of predefined content fields; and
the at least one processor is further to compare a content field in the at least one screen page and the list of predefined content fields to determine that the particular elements of the at least one screen page comprise personal information.

18. The system of claim 12, wherein the at least one processor is further to:
identify, based on the metadata associated with the elements of the plurality of screen pages, a first subset of elements of the at least one screen page comprising personal information; and
identify, using at least one probabilistic technique, at least one further element of the at least one screen page not in the first subset of elements and considered likely to also comprise personal information,
wherein the particular elements determined to comprise personal information are the elements of the first subset of elements and the at least one further element.

19. The system of claim 12, wherein:
the device is a first device; and
the at least one processor is further to obtain a record of the computer-executable instructions being executed on a second device.

20. The system of claim 12, wherein the memory is further to store an indication that the device is associated with a user account not having permission to access the personal information.

21. A non-transitory computer readable medium storing computer executable instructions which, when executed by a computer, cause the computer to:
obtain computer-executable instructions for generating a plurality of screen pages;
determine, based on metadata associated with elements of screen pages of the plurality of screen pages, that particular elements of at least one screen page of the plurality of screen pages comprise personal information;
modify the computer-executable instructions to produce modified computer-executable instructions, the modified computer-executable instructions being to generate at least one modified screen page that corresponds to the at least one screen page having the particular elements of the at least one screen page replaced with corresponding elements including non-personal content corresponding to the personal information; and
transmit the modified computer-executable instructions to a device.
